(19) United States
(12) Patent Application Publication
(10) Pub. No.: US 2015/0037095 A1
(43) Pub. Date: Feb. 5, 2015

(54) METHOD AND DEVICE FOR MANUFACTURING A PART MADE OF A THERMALLY INSULATING COMPOSITE MATERIAL AND SECTION COMPRISING SAME

(71) Applicant: Michel Maugenet, Clapiers (FR)

(72) Inventor: Michel Maugenet, Clapiers (FR)

(73) Assignee: INNOBAT, Clapiers (FR)

(21) Appl. No.: 14/385,494

(22) PCT Filed: Mar. 16, 2012
(86) PCT No.: PCT/FR2012/050554

§ 371 Date: Sep. 15, 2014

(51) Int. Cl. C08J 5/04; D01D 13/00; E06B 3/96; D01D 5/12

(52) U.S. Cl. CPC C08J 5/045; D01D 5/12; D01D 13/00; E06B 3/96; C08J 2375/04
USPC 403/404; 264/172.11; 425/377; 252/62

(57) ABSTRACT

A method for manufacturing a profiled section made of a thermally insulating composite material. A thermoset matrix is injected into an injection box where continuous natural fiber rovings circulate. The continuous natural fiber rovings and a portion of the thermoset matrix are pultruded. The natural fiber volume ratio is between 50 and 70% and a natural fiber mass ratio is between 55 and 75%. During the injection step, the ratio of natural fibers can be adapted so that the composite material has a conductivity of less than 0.30. The continuous natural fiber rovings can be twisted before the steps of injecting and pultruding. Preferably, during the twisting step, a number of turns per meter of between 10 and 30 is transmitted to the continuous natural fiber rovings.

### TECHNICAL FIELD OF INVENTION

The present invention relates to a method and a device for manufacturing a part made of a thermally insulating composite material, a part made of a composite material obtained with this device or this method, and a section comprising same.

The present invention applies, in particular, to the manufacture of a thermally insulating bio-based composite material reinforced with natural fibers, for the industrial and construction sectors, and in particular for joinery.

### BACKGROUND OF THE INVENTION

The materials used in joinery each have drawbacks:
metal, particularly aluminum, is a thermal conductor, and joinery made of metal requires the addition of thermal break strips and is therefore no longer suited to the thermal insulation standards in force or being drawn up;
plastic materials, such as PVC, have weak mechanical characteristics.

These two materials also have a negative environmental impact due to their extraction, synthesis and transformation processes.

As for wood, it is limited by its mechanical performance, its rapid aging and the need for regular maintenance.

The use of natural fibers in composite materials is limited to so-called short fibers, mats and wovens. Short fibers serve mainly as fillers and contribute no mechanical properties. Mats and wovens are beginning to be used to produce parts by infusion or thermoforming.

The parts made of composite material described in documents EP 0 949 058 and US 2004/043206 have no thermal insulation properties and can therefore only be used in applications with low thermal insulation requirements.

Advances in glazing, double and then triple, are such that joinery sections have now fallen behind with regard to the insulation of buildings. Sections made of plastic, e.g. made of PVC, have better thermal insulation than sections made of metal, e.g. made of aluminum. However, for mechanical reasons, in particular rigidity for transportation and installation in the building, either their dimensions are much greater than those of metal sections, thus reducing the glazed area and the amount of solar radiation entering the building, or they must be strengthened by rigid internal metal parts, reducing their thermal properties. However, the increase in the dimensions of the sections, in depth to increase the thermal barrier and in height to support glazed areas that are increasingly thicker and heavier, are contrary to the demands of customers and architects, who look for the thinnest possible sections for esthetic reasons and to favor the entry of light and solar energy.

In order to respect these conflicting requirements, manufacturers have developed PVC sections with reinforcements made of steel, which contribute mechanical resilience. On the other hand, however, thermal performance is significantly degraded. Future thermal requirements make even this solution obsolete. The best existing PVC sections with steel reinforcements have a Uf coefficient of 1.6 to 1.7. The new thermal requirements require sections to be developed with a Uf close to 1.

### OBJECT AND SUMMARY OF THE INVENTION

The present invention aims to remedy all or part of these drawbacks by supplying a material, a method and a device for manufacturing same, a part made with this material, and a section comprising same.

To this end, according to a first aspect, the present invention envisages a part made of a thermally insulating composite material, which comprises continuous natural fiber rovings, forming a reinforcement, and a thermoset matrix, said profiled section being obtained by injecting two components into an injection box where the drawn natural fiber rovings circulate.

Thanks to these provisions, the part made of composite material is suited to the requirements for thermally insulating mechanical parts. The part that is the subject of the present invention can be solid or hollow, for example a profiled section for joinery.

In some embodiments, the ratio of natural fibers is adapted so that the composite material has a conductivity of less than 0.30.

In some embodiments, each natural fiber roving has a Tex index of 1000 to 3000, corresponding to 1 to 3 g/m.

The part thus has high mechanical characteristics.

In some embodiments, the thermoset matrix is a polyurethane-, epoxy-, polyester- or vinylester-based matrix.

In some embodiments, the natural fiber volume ratio is between 50 and 70%.

In some embodiments, the natural fiber mass ratio is between 55 and 75%.

Thanks to each of these provisions, the thermal insulation properties of the part are high.

According to a second aspect, the present invention envisages a method for manufacturing a part made of a thermally insulating composite material, which comprises:
a step of injecting a two-component thermoset matrix into an injection box where continuous natural fiber rovings circulate; and
a step of drawing the continuous natural fiber rovings in order to polymerize the two-component matrix.

In some embodiments, during the injection step, the ratio of natural fibers is adapted so that the composite material has a conductivity of less than 0.30.

In some embodiments, the method that is the subject of the invention comprises, in addition, a step of twisting the continuous natural fiber rovings before the coating step.

In some embodiments, during the twisting step, a number of turns per meter of between 10 and 30 is transmitted to the continuous natural fiber rovings.

The use of lowtwist fiber rovings (ribbons) makes possible the use of the pultrusion process, in which tension is exerted on the fiber rovings, without the fiber rovings (ribbons) unraveling during the pultrusion process and breaking.

According to a third aspect, the present invention envisages a device for manufacturing a part made of a thermally insulating composite material, which comprises:
a means of injecting a two-component thermoset matrix into an injection box where continuous natural fiber rovings circulate; and
a means of drawing the continuous natural fiber rovings in order to polymerize the two-component matrix.

In some embodiments, the injection means is designed to inject the thermoset matrix such that the ratio of natural fibers is adapted so that the composite material has a conductivity of less than 0.30.

According to a fourth aspect, the present invention envisages a joinery section, which comprises:
an external section made of plastic or wood; and
an internal reinforcement formed by a part made of a thermally insulating composite material that is the subject of the present invention.

In some embodiments, the shape and position of the reinforcement are adapted such that the section's temperature coefficient is less than 1.4.

The present invention thus makes it possible to manufacture reinforcements made of a composite material based on natural fibers. Such reinforcements have the advantage of providing the required mechanical performance without degrading the thermal performance. The invention therefore makes it possible to satisfy both current and future requirements applied to joinery sections.

Thanks to each of the aspects of the present invention, the industrial sectors, and in particular the construction sector, can benefit from profiled sections made of a thermoset composite that has high mechanical performance and thermal insulation properties.

In addition, the inventor has discovered that the material thus created has, firstly, very low density, less than that of glass fiber based composites and two times less than aluminum, and, secondly, has significant impact, vibration and sound absorption capacities.

### BRIEF DESCRIPTION OF THE DRAWINGS

Other advantages, aims and characteristics of the present invention will become apparent from the description that will follow, made, as an example that is in no way limiting, with reference to the drawings included in an appendix, wherein:

FIG. 1 shows, schematically, a first particular embodiment of the material manufacturing device that is the subject of the present invention;

FIGS. 2 to 7 show, schematically, experimental results obtained with the material that is the subject of the present invention;

FIG. 8 shows, in the form of a logical diagram, steps utilized in a particular embodiment of the method that is the subject of the present invention;

FIG. 9 shows, schematically, a second particular embodiment of the material manufacturing device that is the subject of the present invention;

FIGS. 10 and 11 show, in cross section, joinery sections of the prior state of the art; and

FIGS. 12 and 13 show, in cross section, joinery sections that are the subject of the invention.

### DETAILED DESCRIPTION OF EMBODIMENTS

Throughout the description, the terms “rovings” and “natural fibers” are used. The first refers to either a thread or a rope formed from natural fibers. The natural fibers include plant fibers and wool fibers, or equivalents. In particular, the fibers utilized in the present invention include linen, cotton, sisal and jute.

As an introduction to the description of the figures, it should be noted that these are not to scale. Throughout the description, the following definition of the composite material is used. The composite material is an assembly of at least two materials that are non-miscible (but with a high adhesive capacity). The new material thus formed has properties that the elements on their own do not have. A composite material is comprised of:
a framework, or reinforcement, which provides the mechanical resilience; and
a protection, known as the matrix, which is generally a plastic (thermosetting resin) and which provides the structure's cohesion and transfers forces to the reinforcement.

Pultrusion is used for the implementation of the present invention. Pultrusion is a continuous method for producing tubes and profiled sections. The term “pultrusion” is a combination of the words “pull” and “extrusion”. The general operation can be summarized as follows: the reinforcement (fabric, mat, fibers), presented as a reel, is impregnated with resin by passage in a bath and pulled through a heated die, which controls the resin content and determines the shape of the cross-section. Passage in the heated die causes the polymerization of the thermosetting resin and gives the final shape. The product is then cut to the required length. In other words, the pultrusion method consists of pulling fiber rovings impregnated with thermosetting resin through a die where the forming and cross-linking are carried out.

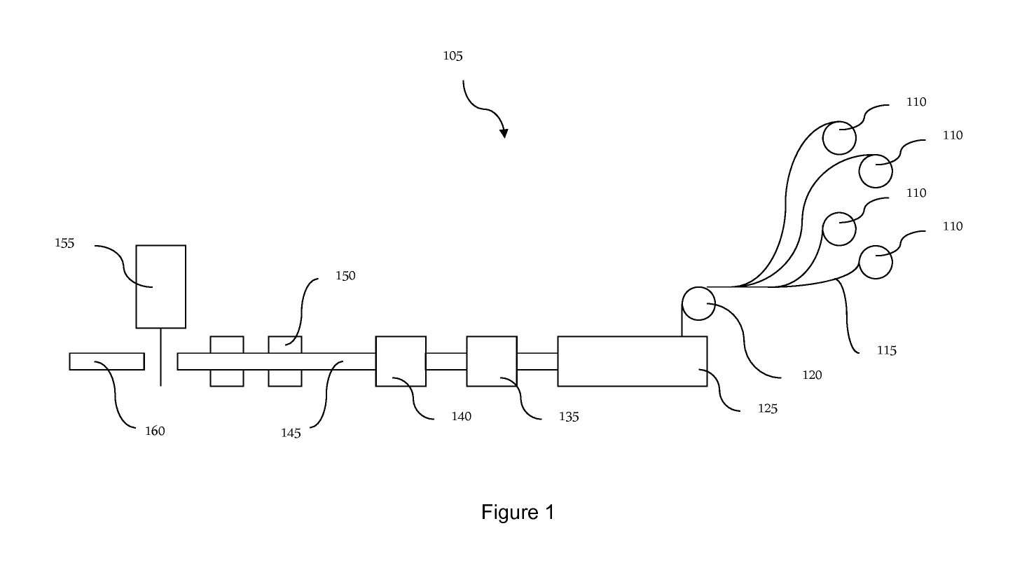

FIG. 1 shows, in a device 105 for manufacturing profiled sections that is the subject of the present invention, a distribution set 110 of natural fiber rovings 115, a set 120 of rolling surfaces for natural fiber rovings, an impregnator 125, an optional means of adding surface protection (not shown), a pre-former 135, a heated die and a post-cure oven 140, a cooling area 145, a pulling means 150 and a cutting-out station 155 supplying profiled sections 160.

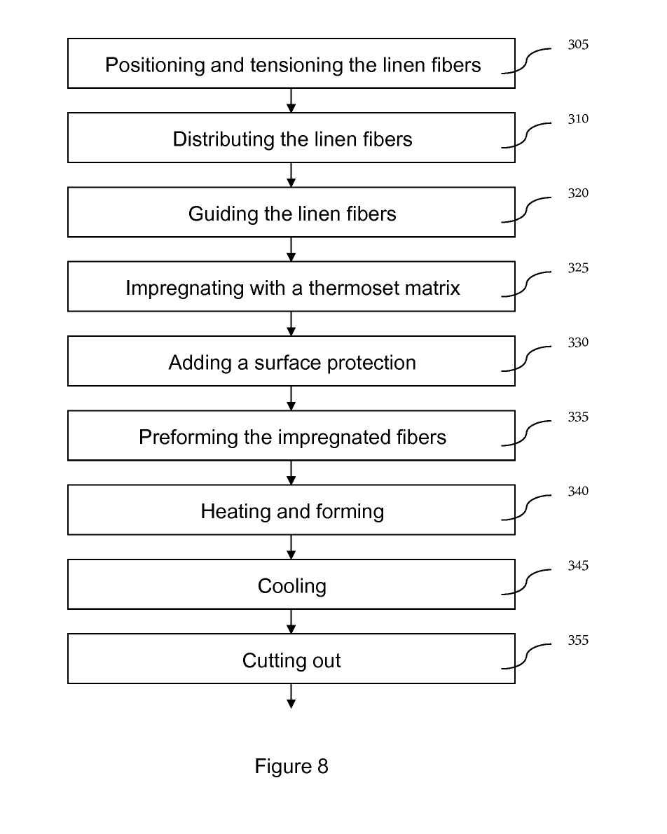

Different steps shown in FIG. 8 correspond to these means. During a step 305, the natural fiber rovings are positioned and tensioned. During a step 310, the natural fiber rovings, slightly twisted beforehand, are distributed. During a step 320, the natural fiber rovings are guided. During a step 325, the natural fibers are impregnated with a thermoset matrix. During an optional step 330, a surface protection is added. During a step 335, the impregnated fiber rovings are preformed. During a step 340, the natural fiber rovings are heated and put into their final form. During a step 345, the profiled section is cooled. During a step 355, the profiled sections are cut.

Each of these means and these steps is detailed below, with reference to FIGS. 3 to 7.

With regard to the distribution set of natural fiber rovings 115 and step 315, reels of natural fiber rovings, as strips or as a continuous ribbon, are utilized. In some embodiments, each reel, commonly called “roving” by the person skilled in the art:
is presented on a cardboard tube with a diameter of the order of 75 millimeters (three inches),
distributes a fiber roving length of 500 to 3000 meters,
the fiber roving has a Tex index of 1000 to 3000, equivalent to 1 to 3 g/m and
the fiber roving is of the lowtwist type, the number of turns per meter (“tpm”) being between 10 and 30, for example approximately fifteen.

The use of lowtwist fiber rovings (ribbons) makes possible the use of the pultrusion process, in which tension is exerted on the fiber rovings, without the fiber rovings (ribbons) unraveling during the pultrusion process and breaking.

According to the sections, the number of rovings utilized ranges from tens to several hundreds.

With regard to the impregnator 125 and the impregnation step 325, this involves impregnating each natural fiber roving with a polyurethane-, epoxy-, polyester- or vinylester-based thermosetting matrix (also called “thermoset”). During the impregnation, the natural fiber rovings are dipped in a bath of thermoset resin associated to a hardener and an accelerator (as well as additives such as a release agent and inorganic fillers).

It is noted that several families of thermosetting resins can be employed, in particular unsaturated polyesters (UP), polyurethanes (PUR), vinylesters and epoxides (EP).

The formulation is adapted to utilization by pultrusion:
at the ambient temperature, the initial viscosity is 500 to 1000 MPas;
the viscosity is approximately 2000 MPas after 6 to 8 hours; and
the level of reactivity allows a peak of 200° C. to be reached after five minutes at 150° C.

With regard to the pre-former 135 and the preforming step 335, a heated die is utilized. The sections produced are solid or hollow, simple or complex.

The inventor has obtained the following characteristics for a solid section with a rectangular cross-section of 30×4.5 mm and for a hollow section with a square cross-section of 30×30 mm:
Young's modulus=35 GPa,
thermal conductivity=0.28,
density approximately 1.4,
fiber volume ratio 60% and, more generally, between 50 and 70%, and
fiber mass ratio 65% and, more generally, between 55 and 75%.

The combination of these properties is especially advantageous for the application of joinery profiled sections. The material combines the insulating power of PVC with the solidity of aluminum while being mainly (around 65%, by mass) bio-based.

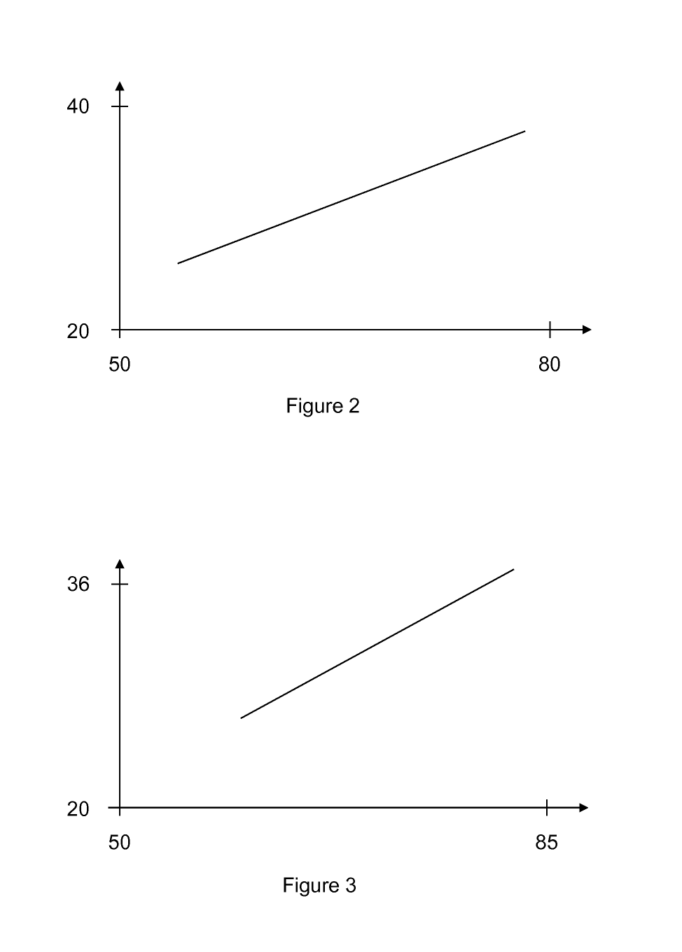

With regard to mechanical performance, FIG. 2 shows the influence of the fiber volume ratio on the tensile elastic modulus (Young's modulus). With regard to mechanical performance, FIG. 3 shows the influence of the fiber mass ratio on the tensile elastic modulus (Young's modulus).

The person skilled in the art will note that Young's modulus increases with the fiber ratio. The person skilled in the art can thus determine a fiber volume ratio according to the performance levels sought, in terms of Young's modulus.

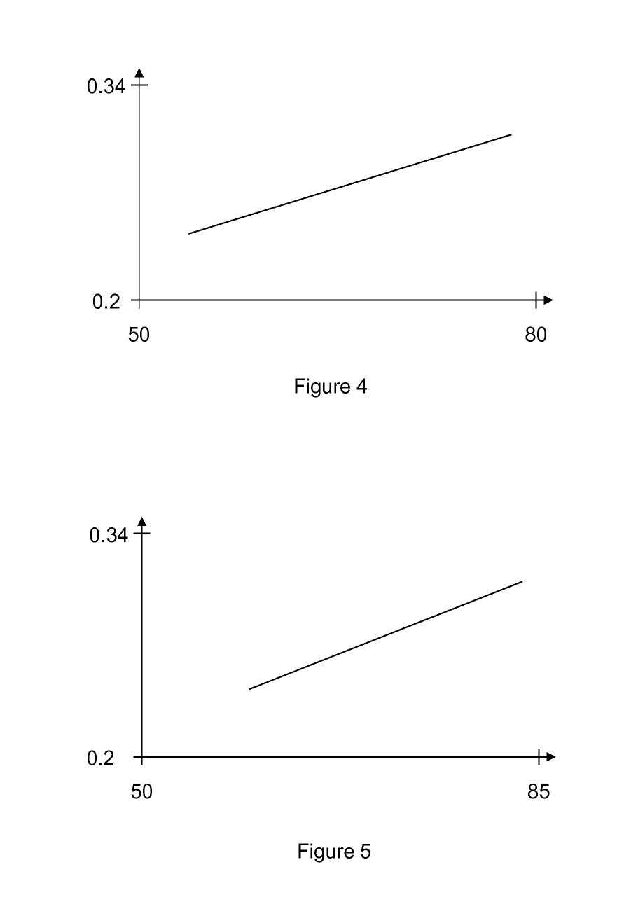

With regard to thermal performance, FIG. 4 shows the influence of the fiber volume ratio on the thermal conductivity. With regard to thermal performance, FIG. 5 shows the influence of the fiber mass ratio on the thermal conductivity.

It is noted here that thermal conductivity is a physical magnitude characterizing the behavior of materials during heat transfer by conduction. Annotated A (or k in English), this constant appears, for example, in Fourier's law (see the article on Thermal Conduction). It represents the quantity of heat transferred per unit of surface area and per unit of time when subjected to a temperature gradient of one degree per meter.

In the International System of Units, thermal conductivity is expressed in watts per meter per Kelvin, (W·m⁻¹·K⁻¹) where:
watt is the unit of power,
meter is the unit of length (thickness/surface, m⁻¹=m/m²) and
Kelvin is the unit of temperature.

The person skilled in the art will note that the thermal conductivity increases with the fiber ratio and can determine a level according to the performance levels sought, in terms of insulating power.

For the fiber volume ratio of 60%, a thermal conductivity of 0.26 is observed. For the fiber volume ratio range of 50 to 70%, the thermal conductivity ranges from 0.235 to 0.285. For the fiber mass ratio of 65%, a thermal conductivity of 0.26 is observed. For the fiber mass ratio range of 55 to 75%, the thermal conductivity ranges from 0.23 to 0.29.

Thus, preferably, the ratio of natural fibers is adapted so that the composite material has a conductivity of less than 0.30. The person skilled in the art can rapidly determine the natural fiber ratio to apply, based on the thermal conductivity specification and the conductivity curves that he obtains with the material that is the subject of the invention.

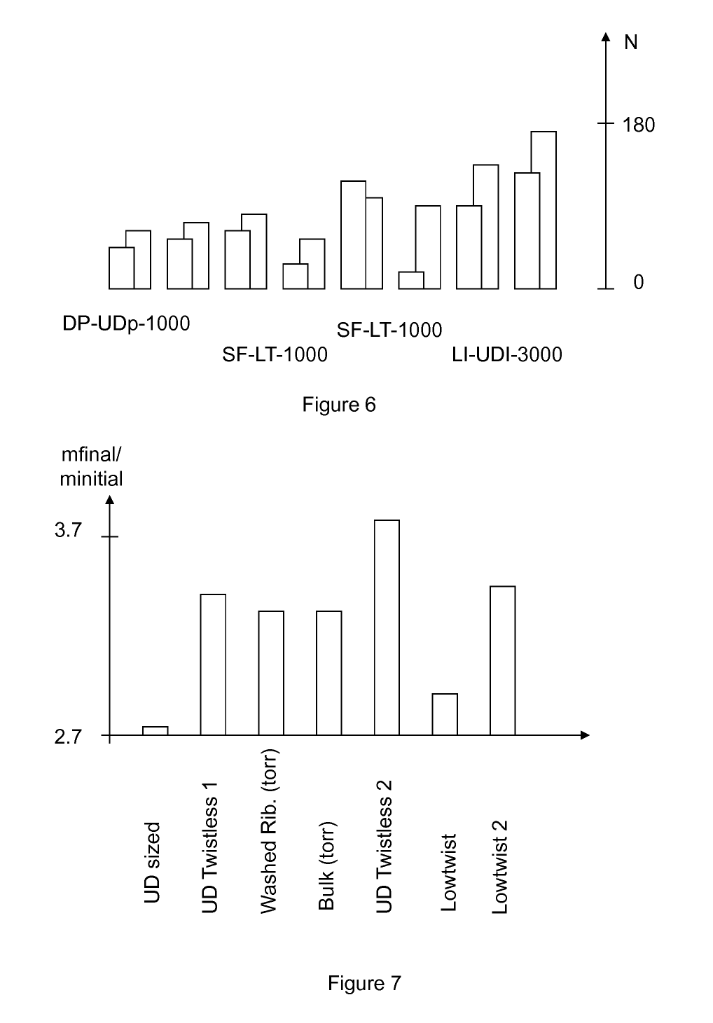

With regard to the tests of the traction exerted on the natural fiber rovings, FIG. 6 shows the tensile strength. The person skilled in the art will note that the tensile strength performance levels differ substantially, according to the type of natural fibers (ribbons), and therefore that not all types of fiber are compatible with the pultrusion process.

With regard to the impregnation tests, FIG. 7 shows impregnation differences for natural fibers depending on their type.

Thanks to the utilization of the present invention, a high mechanical performance, thermally insulating material with outstanding anti-vibration and acoustic damping properties is obtained. In addition, the material thus created has a very low density, less than that of glass fiber based composites and two times less than aluminum.

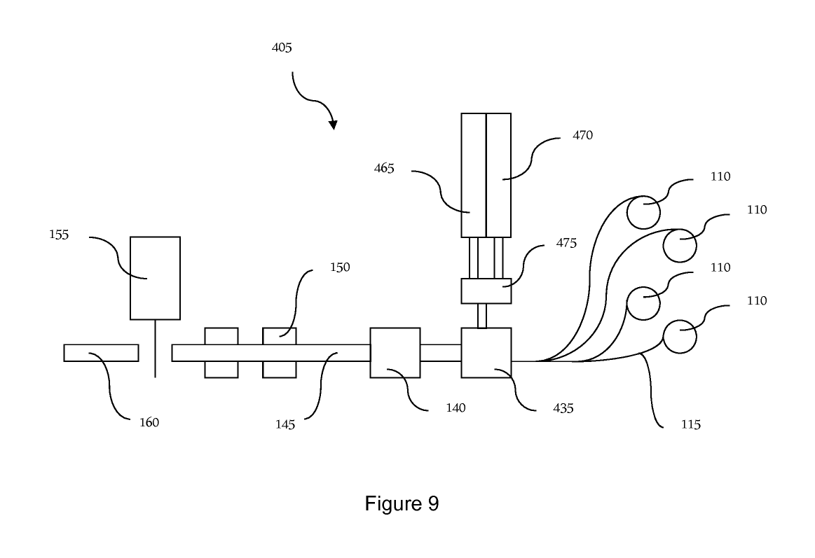

In a variant, pultrusion is replaced by injecting a two-component polyurethane-based thermoset resin at the location of the die. Heating the die allows polymerization of the resin around the natural fiber rovings. FIG. 9 illustrates this variant.

FIG. 9 shows, in a device 405 for manufacturing profiled sections that is the subject of the present invention, a distribution set 110 of natural fiber rovings 115, a heated die and a post-cure oven 140, a cooling area 145, a pulling means 150 and a cutting-out station 155 supplying profiled sections 160.

To these elements, already described with regard to FIG. 1, are added an injection box 435, tanks of products 465 and 470, and a pumps and static mixer unit 475, which pumps the products from the tanks 465 and 470, mixes them and injects the mixture thus obtained into the injection box 435. The product contained in tank 465 is an isocyanate compound. The product contained in tank 470 is a polyol. The isocyanate compound is, for example, a modified diphenylmethane diisocyanate, or MDI. The polyol component is, for example, a polyol polyether.

The two-component thermoset resin obtained by mixing is then injected at the die formed by the injection box 435. Preferably, the components are kept at between 18 and 29° C. They form, for example, urethane connection chains.

This second embodiment has the advantage of allowing complex sections to be produced without using a mat. The product obtained has improved mechanical properties, in particular excellent impact resistance and excellent behavior in the presence of fire or heat.

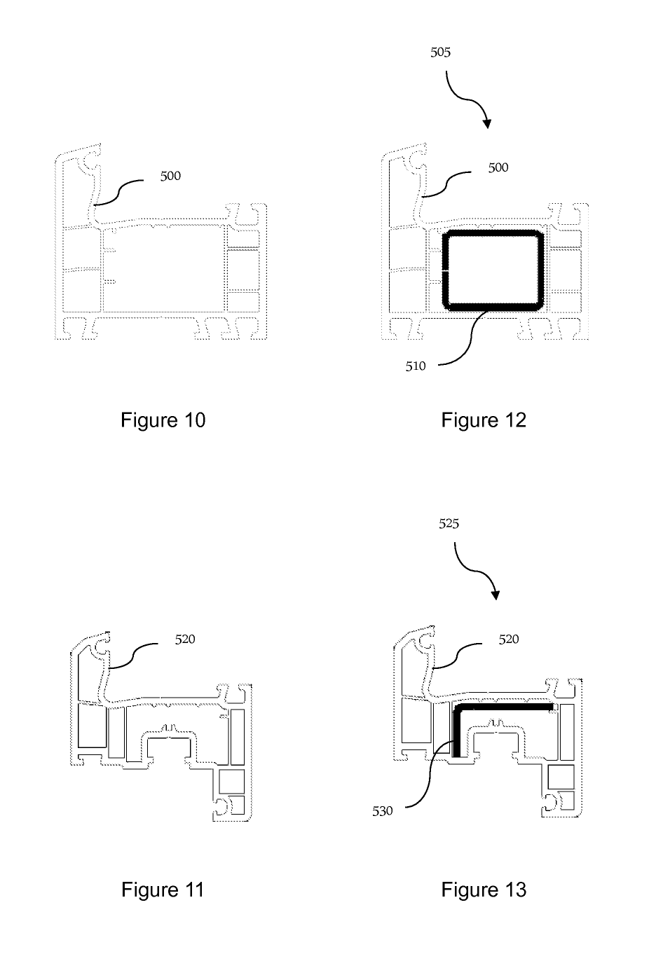

FIGS. 10 and 11 show, in cross-section, joinery sections 500 and 520 of the prior state of the art (registered designs).

As shown in FIGS. 12 and 13, in cross-section, joinery sections 505 and 525 that are the subject of the invention, comprise sections 500 and 520 and, inside these sections, reinforcements 510 and 530, respectively.

The insulating power of a window section is qualified by a Uf coefficient (“f” for frame). The value of this insulating power is expressed in W/m².K. The lower this value, the better the section's insulation.

The Uf coefficient results from the materials used and the design of the section. It is calculated by certified specialized software systems, e g. Bisco from Physibel (registered trademarks). This Uf coefficient is used to determine the Uw coefficient (“w” for window), which characterizes the insulating power of the window manufactured with the sections in question.

The following examples show the effectiveness of the utilization of the present invention:

### EXAMPLE 1

| | Sections | Sections | Sections |
|---|---|---|---|
| | with no | with steel | according to |
| | reinforcement | reinforcement | the invention |
| Uf | 1.4 | 1.7 | 1.4 |
| Uw* | 1.7 | 1.8 | 1.6 |

*Uw value calculated with double glazing Ug = 1.4 and Phi = 0.08

### EXAMPLE 2

| | Sections | Sections | Sections |
|---|---|---|---|
| | with no | with steel | according to |
| | reinforcement | reinforcement | the invention |
| Uf | 1.4 | 1.7 | 1.4 |
| Uw* | 1.2 | 1.4 | 1.2 |

*Uw value calculated with triple glazing Ug = 0.8 and Phi = 0.06

### EXAMPLE 3

| | Sections | Sections | Sections |
|---|---|---|---|
| | with no | with steel | according to |
| | reinforcement | reinforcement | the invention |
| Uf | 1.2** | n/a | 1.2 |
| Uf | 1.1** | n/a | 1.1 |

*Uw value calculated with triple glazing Ug = 0.8 and Phi = 0.06
**with no reinforcement, the height of the sections reduces the glazed area and the incoming solar energy

These tables show the positive role played by reinforcements made of composite material according to the invention in the performance levels of the sections and windows manufactured with these sections. They contribute mechanical resilience and at the same time improve the thermal performance.

In addition, the high proportion of natural fibers improves the carbon footprint, since these are renewable resources and the recycling capacity is improved.

Therefore, one of the direct applications of the invention is the production of window sections made of PVC. In effect, window sections made of PVC have had to evolve over time according to regulatory and architectural requirements. Thus, their dimensions have increased in order to satisfy the continually increasing thermal performance requirements: in depth, to increase the thermal barrier, and in height, to support glazed areas that are increasingly thicker and heavier. This increased size is contrary to the demands of customers and architects, who look for the thinnest possible sections for esthetic reasons and to favor the entry of light and solar energy.

In order to respect these conflicting requirements, manufacturers have developed PVC sections with reinforcements made of steel, which contribute mechanical resilience. On the other hand, however, thermal performance is significantly degraded. Future thermal requirements make even this solution obsolete. The best existing PVC sections with steel reinforcements have a Uf coefficient of 1.6 to 1.7. The new thermal requirements require sections to be developed with a Uf close to 1. This objective cannot be achieved with steel reinforcements.

The present invention makes it possible to manufacture reinforcements made of a composite material based on natural fibers, which have the advantage of providing the required mechanical performance without degrading the thermal performance. The invention thus makes it possible to satisfy both current and future requirements that the sections used in the construction and other industries, in particular joinery window sections, are subject to.

1-14. (canceled)

15. A part made of a thermally insulating composite material, comprising continuous natural fiber rovings, forming a reinforcement, and a thermoset matrix, the part being manufactured by pultrusion, wherein a natural fiber volume ratio is between 50 and 70% and a natural fiber mass ratio is between 55 and 75%.

16. The part according to claim 15, wherein the ratio of natural fibers is configured so that the composite material has a conductivity of less than 0.30.

17. The part according to claim 16, wherein each natural fiber roving has a Tex index of 1000 to 3000, equivalent to 1 to 3 g/m.

18. The part according to claim 15, wherein each natural fiber roving has a Tex index of 1000 to 3000, equivalent to 1 to 3 g/m.

19. The part according to claim 15, wherein the thermoset matrix is a polyurethane-, epoxy-, polyester- or vinylester-based matrix.

20. A method for manufacturing a part made of a thermally insulating composite material, comprising the steps of:
injecting a thermoset matrix into an injection box where continuous natural fiber rovings circulate; and
pultruding the continuous natural fiber rovings and a portion of the thermoset matrix, wherein a natural fiber volume ratio is between 50 and 70% and a natural fiber mass ratio is between 55 and 75%.

21. The method according to claim 20, further comprising the step of configuring the ratio of natural fibers so that the composite material has a conductivity of less than 0.30.

22. The method according to claim 21, further comprising the step of twisting the continuous natural fiber rovings before the steps of injecting and pultruding.

23. The method according to claim 22, further comprising the step of transmitting a number of turns per meter of between 10 and 30 to the continuous natural fiber rovings during the twisting step.

24. The method according to claim 20, further comprising the step of twisting the continuous natural fiber rovings before the steps of injecting and pultruding.

25. The method according to claim 24, further comprising the step of transmitting a number of turns per meter of between 10 and 30 to the continuous natural fiber rovings during the twisting step.

26. A device for manufacturing a part made of a thermally insulating composite material, comprising:
an impregnator injects a thermoset matrix into an injection box where continuous natural fiber rovings circulate; and
a pultruder configured to pultrude the continuous natural fiber rovings and a portion of the thermoset matrix, wherein a natural fiber volume ratio is between 50 and 70% and a natural fiber mass ratio is between 55 and 75%.

27. The device according to claim 26, wherein the impregnator injects the thermoset matrix such that the ratio of natural fibers is adapted so that the composite material has a conductivity of less than 0.30.

28. The device according to claim 26, further comprising a twisting element configured to twist the continuous natural fiber rovings before the thermoset matrix is injected into the injection box and before the continuous natural fiber rovings and the portion of the thermoset matrix are pultruded.

29. A joinery section comprising an external section made of plastic or wood; and an internal reinforcement formed by a part made of a thermally insulating composite material according to claim 15.

30. The joinery section comprising an external section made of plastic or wood; and an internal reinforcement formed by a part made of a thermally insulating composite material according to claim 16.

31. The joinery section comprising an external section made of plastic or wood; and an internal reinforcement formed by a part made of a thermally insulating composite material according to claim 17.

32. The joinery section comprising an external section made of plastic or wood; and an internal reinforcement formed by a part made of a thermally insulating composite material according to claim 19.

33. The joinery section according to claim 29, wherein a shape and a position of the reinforcement are configured such that the joinery section's temperature coefficient is less than 1.4.
